(19) United States
(12) Patent Application Publication
(10) Pub. No.: US 2005/0055476 A1
(43) Pub. Date: Mar. 10, 2005

(54) System and method for processing distributed print jobs

(75) Inventors: Jean Margaret Aschenbrenner, Boulder, CO (US); David Earl Stone, Longmont, CO (US); Reinhard Heinrich Hohensee, Boulder, CO (US)

Correspondence Address: IBM CORPORATION;Intellectual Property Dept. 9CCA/B002, P.O. Box 12195, Research Triangle Park, NC, 27709, US

(73) Assignee: International Business Machines Corp., Armonk, NY (US)

(21) Appl. No.: 10/881,522

(22) Filed: Jun. 30, 2004

Related U.S. Application Data
(60) Provisional application No. 60/500,601, filed on Sep. 5, 2003.

(51) Int. Cl. G06F 3/00

(52) U.S. Cl. 710/15

(57) ABSTRACT

A system, method, program product and data structure for processing a print job distributed between the printer and at least one ancillary printer device. In accordance with the method of the present invention an ancillary device presentation container is received by a print server interface. The presentation container includes an object area field containing object area data and a print data field containing print data. The print server interface converts the ancillary device presentation container into one or more printer commands to be delivered to and processed by a main printer. As part of converting the ancillary device presentation container, the presentation container is identified as having a presentation space mapping specified as an ancillary device interface mapping. In response to identifying the presentation container as having a specified ancillary device interface mapping, printer commands are generated directing the printer to render the object area data and to defer rendering the print data to an ancillary printer device.

### CROSS-REFERENCE TO RELATED APPLICATIONS

The present application is related to and claims priority from Provisional Application No. 60/500,601 filed on Sep. 5, 2003, the content of which is incorporated herein. The present application is also related to co-pending U.S. patent application Ser. No. 2003/0234954 A1, titled “BIDIRECTIONAL PRE- AND POST-PROCESSOR CONDUIT THROUGH A BIDIRECTIONAL PRINTING DATA STREAM,” filed on Jun. 19, 2002, and incorporated herein by reference in its entirety.

### BACKGROUND OF THE INVENTION

1. Technical Field

The present invention relates generally to document presentation and production systems and in particular to a system and method for distributing print processing tasks. More particularly, the present invention relates to a system and method employing page description and printer command mechanisms and techniques to sequentially distribute a print job originating from an application print file between a main printer and pre- or post-processing printing devices.

2. Description of the Related Art

A variety of systems and techniques for post-processing print jobs are commonly employed in most high speed, high volume printing systems. Such post-processing devices allow a variety of processing to be performed on the paper or other media upon which data is printed. An example of such printing system are completely automated systems that produce paper bills to be mailed to customers of utilities or other entities at a rate of from several hundred to over one thousand pages per minute. Such post-processing equipment may include machines that cut, fold, perforate, staple, edge stitch, post-print, unwind paper, insert sheets from the printer or other paper-supply sources into a stack of printer output, shrink wrap a collection of papers and stuff assembled packages of paper into envelopes for mailing.

Specialized system interfaces have been developed to facilitate command processing uniformity and efficiency in the transfer and processing of printing and pre- and post-printing tasks among the various system devices. Prominent among such interfaces is the Universal Printer Pre- and Post-Processing Interface (UP3i) which defines an electrical interface and command protocol conforming to the IEEE 1394 standard enabling seamless interfacing of pre- and post-processing devices with the primary printing system. The UP3i is defined in the UP3i™ Specification, produced by the UP3i Core Group, the entire content of which is incorporated herein by reference.

UP3i may be combined with a document presentation architecture such as IBM's Advanced Function Presentation (AFP) architecture to provide a seamless document pre- and post-processing system. A system that advantageously combines UP3i architecture features with the AFP architecture is described in related Published U.S. patent application Ser. No. 2003/0234954, assigned to the Assignee of the present application, and the entire content of which is incorporated herein by reference.

While current pre- and post-processing architectures solve many of the issues faced in non-printing post-processing tasks (i.e., paper handling task such as cutting, folding, stapling, etc.), several problems relating to sequential printing (i.e., printing tasks distributed among different printing devices) remain unaddressed. Compared with most post-processing tasks (commonly referred to as “finishing operations”), such as cutting or stapling, which require a relative few commands and processing parameter considerations to perform tasks not directly intertwined with the main print job, processing print commands is inherently more complex and process-intensive, involving potentially numerous and oftentimes nested processing considerations.

The relative complexity of integrating pre- and post-processing printing tasks presents significant obstacles to overall document production efficiency. Among such problems is that the complexity inherent in print command processing poses a heightened potential for errors, resulting in a cumbersome process of tracing and returning the error to the host printer or server for correction/recovery. Another problem relating particularly to post-process printing is that delays in the downstream print processing may require the main printer to pause, resulting in a compounded delay and consequent reduction in throughput. The need for high throughput in many high volume printing systems therefore weighs against requiring pre- and post-process printing devices to handle complex printing commands. Instead, for example, most conventional post-processing printing systems are characterized as sending substantially uniform commands (effectively YES/NO) utilized by the post-process printing device to determine whether or not to execute a single, fully pre-programmed printing task.

While maintaining desired throughput levels by alleviating the need to process typical print command parameters such as print object location, sizing, applicable ink, etc., this approach essentially divorces ancillary print command processing from application-generated print job requests and therefore substantially reduces the flexibility of pre- and post-process printing. This approach furthermore necessitates substantial application-specific hardware and software support for ancillary print equipment specialization and interface customization that is cumbersome and costly.

It can therefore be appreciated that a need exists for an improved system and method for distributing print commands to pre- and post-processing printing devices that enables the devices to flexibly process application-specific commands while minimizing the complexity of the ancillary print command architecture. The present invention addresses these and other needs unresolved by the prior art.

### SUMMARY OF THE INVENTION

A system, method, program product and data structure for processing a print job distributed between the printer and at least one ancillary printer device are disclosed herein. In accordance with the method of the present invention an ancillary device presentation container is received by a print server interface. The presentation container includes an object area field containing object area data and a print data field containing print data. The print server interface converts the ancillary device presentation container into one or more printer commands to be delivered to and processed by a main printer. As part of converting the ancillary device presentation container, the presentation container is identified as having a presentation space mapping specified as an ancillary device interface mapping. In response to identifying the presentation container as having a specified ancillary device interface mapping, printer commands are generated directing the printer to render the object area data and to defer rendering the print data to an ancillary printer device.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a simplified block diagram representation of a printing communications system in accordance with the present invention;

FIG. 2 is a high-level diagram representation of a system print flow in accordance with a preferred embodiment of the present invention;

FIG. 3 is a simplified block diagram representation of an ancillary print command distribution system in a preferred embodiment of the present invention;

FIG. 4 illustrates an exemplary presentation container data structure in accordance with a preferred embodiment of the present invention; and

FIG. 5 is a high-level flow diagram depicting steps performed during print job processing in accordance with the present invention.

### DETAILED DESCRIPTION OF ILLUSTRATIVE EMBODIMENT(S)

The present invention is directed to a method, system, computer program product and data structure that enable functional connection of printing equipment including mutually coupled workstations, print servers, and printers, with pre- and post-processing printing devices, referred to herein generically as ancillary printing devices. While the invention will be described in the general context of one or more specifically designated electronic devices, program modules and data structures within a specified distributed printing environment, those skilled in the art will recognize that the invention may also be implemented in a variety of possible hardware and software configurations. Moreover, those skilled in the art will appreciate that the invention may be practiced in distributed computing environments where tasks are performed by remote processing devices that are linked through a communications network. Examples of such distributed computing environments include local area networks of an office, enterprise-wide computer networks, and the Internet.

Those skilled in the art will recognize that the invention may be implemented in a variety of ways using a variety of combinations of program modules. Program modules generally include routines, programs, components, data structures, etc. that perform particular tasks or implement particular abstract data types. Moreover, those skilled in the art will appreciate that the invention may be practiced with other computer system configurations, including multiprocessor systems, microprocessor-based systems, minicomputers, mainframe computers, and the like.

The terms “document,” “page,” “overlay,” and “sheet” are utilized in the present description and are intended to convey the same meaning as such terms are widely understood in the art. Namely, a “document” is generally a data collection created by an application program, such as a word processing application, that is logically subdivided into pages. A “page” comprises objects, such as text, images, graphical objects, and display elements, that are to be displayed on one side of a sheet, subject to various formatting specifications, such as size, margins, font, color, depth, etc. When printed, document pages are presented on “sheets”, which are presentation units within the document generally having at least two sides (e.g., a front side and a back side). Each side of a sheet may contain one or more pages. A page may also include one or more overlays. An overlay is a pre-defined page or part of a page that a print server sends to a local printer memory and is typically used to present fixed data on a document that does not move with respect to the sheets.

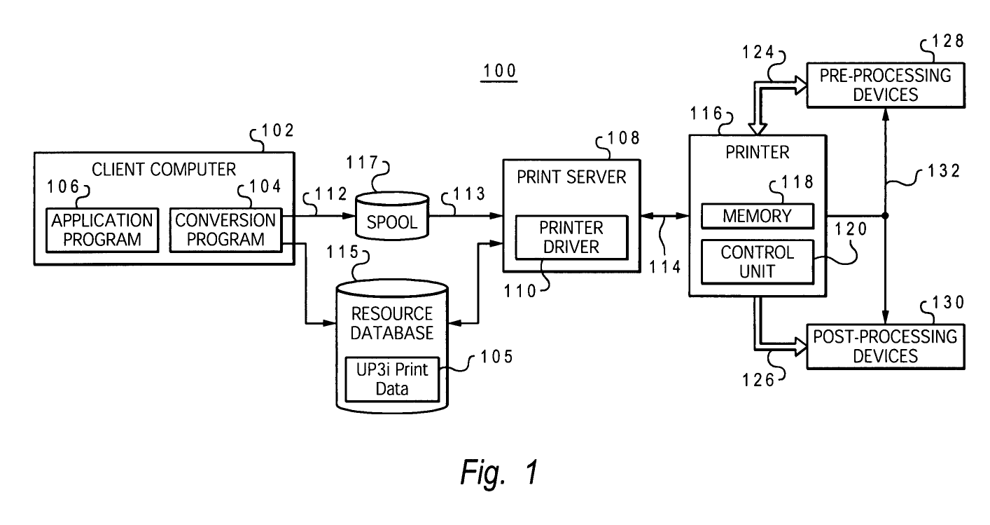

With reference now to the figures, wherein like reference numerals refer to like and corresponding parts throughout, and in particular with reference to FIG. 1, there is depicted a printing communications system adapted for implementing the present invention. Specifically, FIG. 1 illustrates an Advanced Function Printing (AFP) system 100 for printing and pre- or post-process printing a print document in accordance with the present invention. A printing cycle executed by AFP system 100 begins with a print document generated by an application program 106 within a client computer 102. Application program 106, running on client computer 102, generates a print document data stream that contains page description information including, for example, application program specific print objects.

The application print objects forming the print document description are received by a conversion program 104 that generates a page description language (PDL) data stream 112 which is a formatted, platform, device and resolution independent, logical description of the print document. In the process of forming data stream 112 conversion program 104 stores certain information, such as fonts and formatting information, in a common resource database 115. Conversion program 104 then generates a logical description of the document with references to information stored in resource database 115. In particular, such a logical description of a data stream utilized for printing in the depicted AFP system 100 is the Mixed Object Document Content Architecture (MO:DCA) file format, which is discussed in more detail below.

The print data in MO:DCA format containing references to the resources maintained in database 115 is stored in a spool 117 or may be carried in a resource group that is part of the actual print file. Spool 117 both stores and spools the MO:DCA data stream 112 representing the print document from the conversion program 104. The spooled output data stream 113 is transmitted to a print server 108 that converts the device-independent print specifications to a device specific data stream 114 by means of a printer driver 110 in concert with the resource database 115. Resource database 115 is utilized to convert the MO:DCA data stream 113 to a print data stream 114 including details of a physical medium using a process called “outboard formatting.” The resulting data stream 114, called an Intelligent Printer Data Stream™ (IPDS™, trademark of IBM Corporation, Armonk, N.Y.), is sent to a printer 116.

Printer 116 includes a control unit 120 with which print server 108 is communicatively coupled and an internal memory 118. The communication between the print server 108 and printer 116 is bidirectional. For example, print server 108 may inquire of printer 116 whether a particular resource, such as a font, is resident in printer memory 118. If the resource is not present, print server 108 can retrieve the font from resource database 115 and download it via data stream 114 into printer memory 118 where it will be available for future use. Subsequently, when print data that refers to the downloaded resource is received by printer 116, the printer will combine the resource with the data and provide the combination to a conventional Rasterizing Image Processor (called a “RIP”, not shown in FIG. 1) which converts the data into a printable graphic image.

An exemplary generalized representation of a page description data stream for a two page print document in the MO:DCA format is shown below. The document consists of structured fields that can contain data or control information. The structured fields are specified in accordance with the MO:DCA protocol as follows:

BDT

BPG1

BAG
page 1 resource data reference
EAG

page 1 print data

EPG 1
BPG2

BAG
page 2 resource data reference
EAG

page 2 print data

EPG2

EDT

The document includes a Begin Document structured field (BDT) for marking the beginning of the print document, and an End Document structured field (EDT) for marking the end of the document. Similarly, the two pages each have a Begin Page structured field (BPG) for marking the beginning of each page, and an End Page structured field (EPG) for marking the end of each page.

Each page has a resource area defined between a Begin Active Environment Group structured field (BAG) and an End Active Environment Group structured field (EAG). This area contains references to fonts, bitmaps, etc. which are used to print the page print data that follows the active environment area.

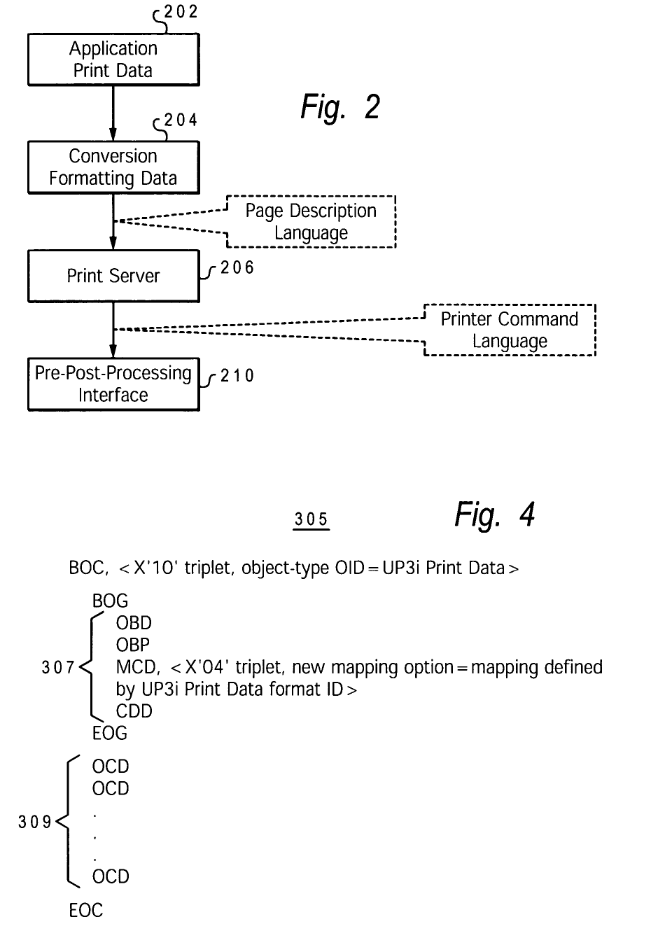

As noted above, print server 108 sends data to printer 116 via IPDS data stream 114. In this stream, non-native data, such as Encapsulated Postscript (EPS) and Portable Document Format (PDF) data, is carried in containers. Each container has a control field and a data field used to convey both formatting control data and printable data. As explained below with reference to FIGS. 2-5, the system, method, program product and data structure of the present invention employ a modified presentation object container format containing ancillary equipment printing commands and which are strategically generated and processed in a manner enabling flexible and transparent execution of pre- and post-processing print jobs. The formatting and processing of such presentation containers will be discussed in further detail below.

Referring now to FIG. 2, there is depicted a high-level diagram illustrating a print flow in which the system, method and data structure of the present invention may be advantageously utilized. A workstation application program generates application print data 202 for a print job and sends the print data to formatting application 204 which generates output for printing in the form of a PDL or presentation data stream. An example of a presentation data stream is Mixed Object Document Content Architecture for Presentation (MO:DCA-P), a product of International Business Machines (IBM) of Armonk, N.Y. This data stream is formatted as a device and resolution independent PDL.

The presentation data stream is sent to print server 206 which processes page and data objects within the PDL data stream utilizing print device specific conversion techniques such as using form definitions that may be included in the presentation stream itself or may be retrieved from a resource library (not depicted). As further depicted in FIG. 2, print server 206 converts the MO:DCA-P data stream into a device-specific print command language data stream. In an exemplary embodiment of the present invention featuring IBM's AFP architecture, the print command language is IPDS™, a product of IBM. The IPDS architecture permits a two-way dialogue between print server 206 and a printer 210 that, in the depicted embodiment, provides a pre- and post-processing interface for interfacing finishing devices such as cutter and stapler devices as well as ancillary printers with the print data flow. This two-way dialogue provides for page-level error recovery. For example, if printer intervention is required during a given print job, printer 210 can resume printing at the next page in the job, so that no data is lost and the job does not have to be re-sent to printer 210.

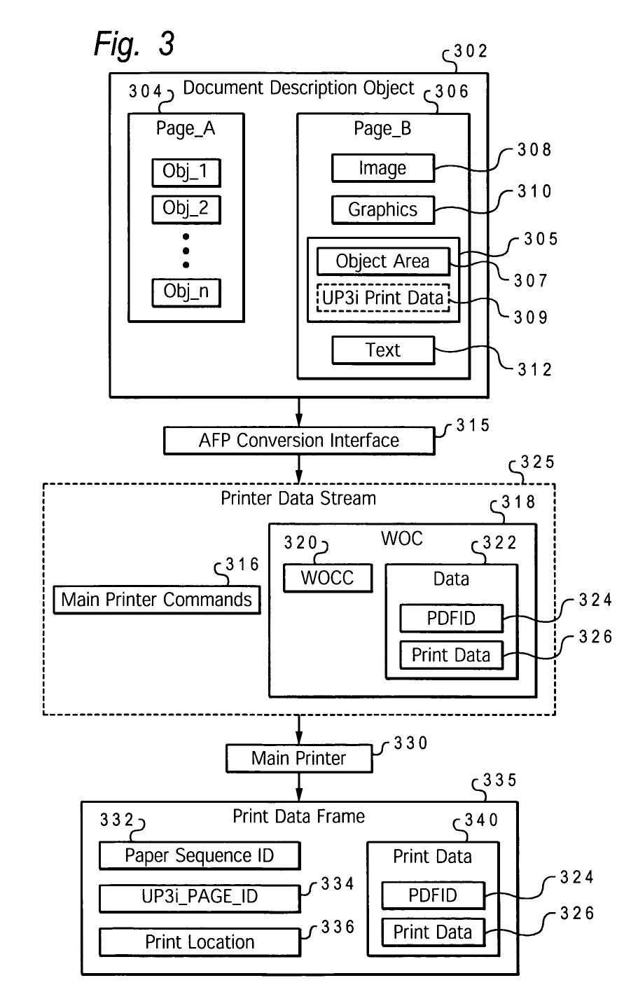

With reference to FIG. 3, there is depicted a simplified block diagram representation of an ancillary print command distribution system in a preferred embodiment of the present invention. The print command distribution system generally comprises advantageously formatted data structures and data streams processed by an AFP conversion interface 315 and a pre- and post-processing interface included within a main printer 330. AFP conversion interface 315 is preferably deployed from a print server such as print server 108 that is communicatively coupled to receive PDL print documents from an application and/or page description conversion program. One such document is represented in FIG. 3 as document description object 302, which in accordance with AFP convention is a MO:DCA formatted document. As is known in the art, MO:DCA defines a device-independent data stream format for interchanging documents among AFP compatible products. As utilized herein, an “object” is a collection of structured fields. The first structured field typically provides a begin-object function and the last structured field provides an end-object function. An object may contain one or more other objects defined by corresponding structured fields whose content consists of one or more data elements of a particular data type. An object is generally assigned a name used in referencing the object. Examples of objects are image, graphics, text, page, and document objects.

As per MO:DCA convention, document description object 302 contains data including control information such as position, orientation, and font selection intermixed with the data to be printed which may include text, graphics, images, bar codes, etc. The data within document description object 302 includes a page object Page_A 304. Consistent with page object convention, Page_A 304 is delimited by a Begin Page structure field (not depicted) and an End Page structured field (not depicted) between which are defined a group of one or more data objects Obj_1 through Obj_n containing bundled object data and defining presentation data in respective presentation spaces within the page.

AFP conversion interface 315 includes electronic and program processing means for receiving data conforming to the MO:DCA data structures contained within Page_A 304 and converting the data structures into printer commands 316 for driving main printer 330. In accordance with AFP processing convention, AFP conversion interface 315 converts the MO:DCA format data structures into device-dependent IPDS print commands delivered to main printer 330 via an IPDS data stream 325. The object printer 330 receives IPDS stream 325 and employs document formatting and rasterizer processing techniques to determine where data is positioned in page presentation spaces and to render the data thereon.

The majority of print data contained within a PDL stream, such as document description object 302, is processed in like manner wherein MO:DCA structured objects are converted to IPDS commands 316 received within IPDS data stream 325 and rendered by a main printer 330. In accordance with the present invention, the system illustrated in FIG. 3 further advantageously enables ancillary (i.e., pre- and post-processing) print commands to originate within a MO:DCA formatted document and be subsequently processed and distributed to pre- and post-processing equipment in a flexible and substantially transparent manner. In the depicted embodiment, main printer 330 serves as a UP3i host interface and employs processing means and a bus protocol conforming to the UP3i standard that defines a protocol by which pre- and post-processing devices, such as devices 128 and 130 shown in FIG. 1, may be communicatively coupled to receive document processing commands.

As an exemplary embodiment of the present invention, document description object 302 further includes a Page_B 306 object similarly containing a number of presentation data objects including, for example, an image object 308, a graphics object 310 and a text object 312 that are formatted and processed in accordance with conventional AFP principles. In addition, Page_B 306 includes an ancillary device presentation container object 305 structured and formatted such that the print data object(s) contained therein are ultimately rendered on a physical print medium such as a sheet of paper by a pre- or post-processing printing device, such as one of devices 128 or 130 shown in FIG. 1. As is known in conventional MO:DCA constructs, a presentation container is generally employed as a generic wrapper for directing transport of presentation data formatted in a page description language other that MO:DCA, such as an Adobe Corporation's Portable Document Format (PDF) language object. The present invention leverages and modifies conventional MO:DCA presentation container formatting and processing design to define an ancillary device presentation container, such as presentation container 305, that is structured and processed in a manner enabling efficient and flexible pre- or post-process printing of application-specified print data contained therein. Prominent among the structure and processing features of the ancillary device presentation container of the present invention are features enabling print object mixing, presentation page object area mapping, and sheet location placement.

Referring to FIG. 4 in conjunction with FIG. 3, an exemplary data structure construct embodying ancillary device presentation container 305 is now described. Consistent with MO:DCA convention, the content of a presentation container is specified using an Object Classification (X‘10’) triplet that is mandatory on a Begin Object Container (BOC) structured field. This triplet carries the object-type object identifier (OID) for the content, which is a unique identifier that is registered, such as within the MO:DCA registry, for each non-native object type in the page description architecture (e.g., MO:DCA). As shown in FIG. 4, ancillary device presentation container 305 has a type specified as OID=“UP3i Print Data” corresponding to the object container registry entry within the MO:DCA registry.

As further illustrated in FIGS. 3 and 4, the data within presentation container 305 is contained within an object area field 307 and a corresponding print data field 309. Print data field 309 includes one or more Object Container Data (OCD) fields containing the print data bytes to be rendered by a specified ancillary printing device. In keeping with the goal of providing a “UP3i conduit” in the AFP architecture, the data within print data field 309 is the data eventually carried in a UP3i Print Data frame 335 on the UP3i interface 330. The syntax of the print data within print data field 309 therefore conforms to the UP3i specification and contains two findamental pieces of information: the print data bytes to be presented; and a format identifier, typically included within the first OCD field, that specifies how the data is encoded and how it is to be presented. The format identifier, referred to herein as the Print Data Format ID (PDFID) is a unique identifier that is registered with the UP3i specification, and may be included such as within a UP3i Print Data resource repository 105 within resource database 115. For example, a ‘Print Data format 1’ format identifier within print data field 309 may specify that the data is a set of code points encoded in Unicode, and is to be presented as a specific bar code type using invisible ink. As another example, a ‘Print Data format 2’ might specify that the data is a set of code points encoded in ASCII, and is to be presented as a text string using a specified MICR font.

Object area field 307 contains presentation data defining a typically rectangular area within the page presentation space, called the object area, into which the corresponding data object specified by the print data is mapped. Consistent with MO:DCA convention, an object area descriptor OBD specifies the size of the object area and an object area position descriptor OBP specifies the offset of the object area origin with respect to the page origin and further specifies the rotation of the object area about its origin. In accordance with the present invention, object area field 307 further includes a Map Container Data (MCD) structured field that defines how the container object space (defined by the object) is mapped into the object area specified by the OBD and OBP fields. In a departure from PDL convention, the MCD field within object area field 307 specifies that the mapping of the data object within the page-defined presentation space (i.e. mapping of the print data to the MO:DCA object area specified by the OBD and OBP fields) is deferred to the mapping format employed by the ancillary equipment interface specification (e.g. UP3i). Specifically, the MCD structured field within object area field 307 specifies that the definition of the presentation space mapping of the print data to the object area is specified by the UP3i print data format ID included within print data field 309. Referring back to the foregoing examples, Print Data format 1 might define the mapping such that the bar code is centered in the object area while an alternate Print Data format 2 might define the mapping such that the text string is positioned such that the characters start at the object area origin and progress in the x-direction of the object area.

In addition to processing means for converting standard MO:DCA objects 308, 310, and 312 into main printer commands 316, the conversion interface 315 of the present invention further includes electronic and program processing modules for receiving and processing presentation container 305 as follows. AFP conversion interface 315 converts presentation container 305 into an IPDS format Write Object Container (WOC) 318 that divides the MO:DCA presentation container data into control (header) information and data. In the exemplary embodiment, WOC 318 includes an object data field 322 that defines the object presentation space and a Write Object Container Control (WOCC) field 320 that defines the object area. Object data field 322 contains the print data 326 including the specified UP3i print data format ID (PDFID) 324 from print data field 309. While the UP3i object presentation format is specified in PDFID 324, WOCC field 320 contains the object area location offset (typically from the page or overlay origin) specified by the MO:DCA OBP field within object area 307. Furthermore, WOCC 320 contains the object area dimensions from the MO:DCA OBD field as well as an orientation specifier that defines the angular rotation of the object area (e.g. 0, 90, 180, 270 degrees) about its origin point. Optionally, WOCC 320 may include a color specification triplet or presentation space reset mixing triplet which specifies the object area coloring or shading.

AFP conversion interface 315 further includes electronic and program modules for interpreting the page description stream to determine the so-called mixing of page description data. Conventional MO:DCA mixing rules, such as those applied to Page_A 304, require that an object is mixed with the remainder of the page data based on the sequential order in which an object is specified in the received page description, and also based on the definition of foreground and background specified for the object. Since the print data 309 is ultimately processed by an ancillary printing device after or possibly before Page_B 306 is rendered by printer 330, the formerly mentioned sequential order mixing requirement presents an obstacle to adherence to standard MO:DCA mixing rules for mixing object presentation data within presentation container 305 with the remainder of the page data. The present invention addresses this with an extension to the mixing rules implemented by conversion interface 315 in conjunction with main printer 330 as follows.

AFP conversion interface 315 converts the MO:DCA specified object area into the device dependent printer command format field WOCC 320 that is processed and mixed by printer 330 according to standard MO:DCA mixing rules. That is, the object area description is processed in accordance with its sequential order within the page description of Page_B 306 and in accordance with specified foreground and background definitions. For example, an empty object area is transparent. If a Presentation Space Reset (X‘70’) Mixing triplet is specified in the OBD, the area under the object area can be reset to color of medium. If a Color Specification (X‘4E’) triplet is specified on the OBD, the object area is colored accordingly. While the object area characteristics are mixed by printer 330, the print data included within print data field 309 and subsequently contained within object data field 322 is rendered in its own presentation space by the target ancillary printing device in accordance with PDFID 324.

The subsequent mixing of the UP3i print data 322 (not the object area) is preferably defined in the MO:DCA architecture in a registry entry for the UP3i Print Data object-type. The preferred mixing is the mixing defined by the selected specific Print Data Format. In particular, for the UP3i Print Data, the MO:DCA mixing is characterized by the definition of the foreground/background as follows.

Foreground=this object does not mix in accordance with the default MO:DCA mixing rules. For a description of the appearance of this object type when rendered, see the Print Data Format ID Triplet as defined in the UP3i specification.

Background=this object does not mix in accordance with the default MO:DCA mixing rules. For a description of the appearance of this object type when rendered, see the Print Data Format ID Triplet as defined in the UP3i specification.

In the Print Data Format ID Triplet, the foreground and background of each ancillary presentation container object is defined and utilized in mixing.

From AFP conversion interface 315, WOC, 318 is delivered via IPDS print command stream 325 to main printer 330, serving as a UP3i interface host. Main printer 330 prints and mixes the object area specified by WOCC 320 with other page data within Page_B 306 in accordance with the aforementioned standard MO:DCA mixing rules. Printer 330 renders the object area data on a sheet in accordance with the object area location specifier OBP (i.e. where object area is located as offset from the page). Furthermore, and assuming UP3i convention whereby the ancillary printing medium origin is specified with respect to a sheet, printer 330 translates the offset specified relative to the page (or overlay) origin to an offset relative to the UP3i medium origin, which is typically the left corner of the leading edge of the sheet. The original object-area-specified offset is processed by printer 330 in rendering the object area and the converted offset is included in a print location field such as Print Location triplet 336 within print data frame 335. In support of such offset conversion, AFP conversion interface 315 may be required to convert offset dimensions if such dimensions differ between the printer (typically AFP L-units) and the target ancillary printing device (typically millipoints=1/72,000 inch).

In addition to mixing the object area specified by WOCC 320, main printer 116 processes WOC 318 to generate a UP3i Print Data frame 335 in accordance with the present invention. Print Data frame 335 is generated and delivered by printer 330 (serving as the host UP3i interface device) directly to the target ancillary UP3i printing device in accordance with the UP3i protocol. Specifically, and in accordance with the depicted embodiment, Print Data Frame 335 includes several triplet data structures including a paper sequence ID triplet 332, a UP3i_PAGE_ID triplet 334, a Print Location triplet 336, and a Print Data triplet 340. As explained below Print Data triplet 340 contains the original print data 309 from presentation container 305 in the form of a UP3i Print Data Format ID 324 and print data 326.

Consistent with UP3i convention, Paper Sequence ID triplet 332 includes the IDs of the sending device (printer 330) and the destination device (target ancillary printing device). UP3i_PAGE_ID triplet 334 includes the UP3i_PAGE_ID which is an ID used to track the page and all operations that are attached to the page as it passes through the main printer and all ancillary processing devices. Print Data triplet 340 is a modification of conventional UP3i Print Data frame content and holds the UP3i Print Data Format ID 324 as well as print data 326 as obtained from WOC object 318. Print Location triplet 336 is a further modification of conventional UP3i Print Data frame content and a feature of the present invention that contains the location, in terms of the converted offset from the specified sheet origin, of the print data object 326. The location offset specified by Print Location triplet 336 is expressed in units consistent with those used by the targeted device, such as in millipoints (1/72,000 inch) from the UP3i medium origin. For further extendability, and in accordance with an alternate embodiment, an object area size specifying height and width, and an object area orientation specifying rotation of the object area about the location specified in the triplet, are also included in Print Location triplet 336. It should be noted that while only one Print Data triplet 340 and one Print Location triplet 336 are included in the depicted embodiment, multiple such triplets may be included with a Print Data frame without deviating from the spirit or scope of the present invention.

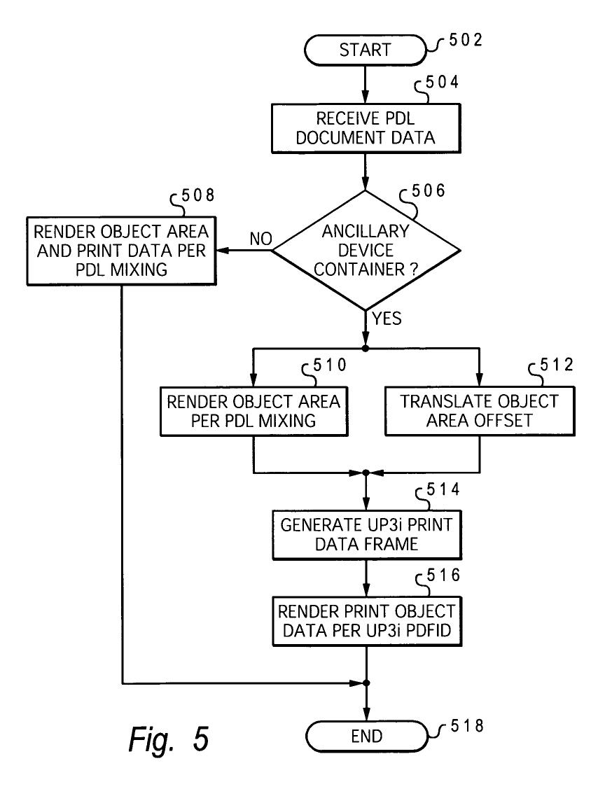

Referring to FIG. 5, there is illustrated a high-level flow diagram depicting steps performed during print job processing such as may be performed by the ancillary print command distribution system shown in FIG. 3. The process begins as depicted at steps 502 and 504 with an AFP interface receiving PDL objects that may be included in an application-specified PDL document. Received objects not identified as ancillary device presentation containers, such as my be determined by the MO:DCA OIDs, are converted to printer commands directing the printer to render the object data contained therein as per PDL mixing rules as illustrated at steps 506 and 508. If, however, the object is identified at step 506 as an ancillary device presentation container, such as may be determined by an OID specifying a UP3i object or other the criteria described with reference to FIG. 3, the container is processed in a manner enabling page-specific object area data to be processed by the printer and data object(s) contained therein to be processed and rendered by a target ancillary device.

Specifically, the object area data originally carried in the presentation container is copied to a control field or a functional equivalent within an IPDS write object container. As depicted at step 510, the main printer renders the object area in accordance with the object area data as per PDL (e.g. MO:DCA) mixing rules as explained with reference to FIG. 3. As a further container processing step performed by the main printer, or equivalent ancillary device interface mechanism, the page specific offset specified in the object area data is translated to a ancillary print medium offset as shown at step 512.

Following object offset translation, and as depicted at step 514, the main printer generates a UP3i print data frame containing the UP3i print data and PDFID as originally specified in the presentation container and also the translated offset. The process concludes as illustrated at steps 516 and 518 with the target ancillary device rendering the print object data contained in the print data frame in accordance with the offset, PDFID and other data included in the data from.

As described in the context of the foregoing embodiments, the present invention provides a system and method wherein ancillary device specific data is encoded in the original page description document, enabling a main printer to generate the targeted Print Data frame independent of information relating to the print task parameters specific to each of the ancillary printing devices. In the foregoing manner, a format-specific UP3i print command can be delivered directly from its MO:DCA encapsulated form to be executed by the target ancillary device with substantial transparency through the AFP portion of the system.

The foregoing disclosed system and method may be readily implemented in software using object or object-oriented software development environments that provide portable source code that can be used on a variety of computer or workstation hardware platforms. Alternatively, the disclosed computer controlled print presentation system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The computer controlled presentation systems and methods described above, however, can be readily implemented in hardware and/or software using any known or later-developed systems or structures, devices and/or software by those skilled in the applicable art without undue experimentation from the functional description provided herein together with a general knowledge of the computer arts.

While the invention has been particularly shown and described with reference to a preferred embodiment, it will be understood by those skilled in the art that various changes in form and detail may be made therein without departing from the spirit and scope of the invention.

1. In a printing system that converts page description commands generated by a host application to printer commands processed by a printer, a method for processing a print job distributed between the printer and at least one ancillary printer device, said method comprising:
receiving an ancillary device presentation container having an object area field containing object area data and a print data field containing print data; and
converting the ancillary device presentation container into one or more printer commands, said converting comprising:
identifying the ancillary device presentation container as having a presentation space mapping specified as an ancillary device interface mapping, and in response thereto, generating printer commands directing the printer to render the object area data and to defer rendering the print data to an ancillary printer device.

2. The method of claim 1, wherein the ancillary device presentation container is included within a page description language (PDL) document having other page object data, said method further comprising utilizing the printer to render the PDL document responsive to the one or more printer commands, said rendering comprising mixing the object area data with the other page object data in accordance with PDL-defined mixing rules.

3. The method of claim 2, wherein the ancillary device presentation container is a Mixed Object Document Content Architecture (MO:DCA) presentation container included within a MO:DCA page, said mixing further comprising mixing the object area data with the other page object data in accordance with the sequential order in which the MO:DCA presentation container occurs with respect to the other page object data within the MO:DCA page.

4. The method of claim 2, wherein said utilizing the printer to render the PDL document further comprises rendering the object area data on a print medium in accordance with an object area location specifier included with the object area data, said object area location specifier specifying the offset of the object area origin with respect to a page origin.

5. The method of claim 4, further comprising translating the offset specified by the object area location specifier to an ancillary print medium offset.

6. The method of claim 5, further comprising generating an ancillary device print data frame containing the translated offset.

7. The method of claim 1, wherein said converting the ancillary device presentation container into one or more printer commands comprises generating a printer command container having a data field and a control field.

8. The method of claim 7, wherein the control field includes object area data corresponding to the object area data contained in the object area field of the ancillary device presentation container.

9. The method of claim 7, wherein the data field includes a print data format ID field specifying format data corresponding to ancillary printer interface data contained in the print data field of the ancillary device presentation container.

10. The method of claim 9, wherein the data field includes object data to be rendered by an ancillary printer device.

11. The method of claim 10, further comprising generating an ancillary device print data frame containing the printer command container object data and the print data format ID.

12. A print command distribution system for processing a print job distributed between a printer and at least one ancillary printer device, said system comprising:
processing means for receiving an ancillary device presentation container having an object area field containing object area data and a print data field containing print data; and
processing means for converting the ancillary device presentation container into one or more printer commands, said processing means for converting comprising:
processing means for identifying the ancillary device presentation container as having a presentation space mapping specified as an ancillary device interface mapping, and in response thereto, generating printer commands directing the printer to render the object area data and to defer rendering the print data to an ancillary printer device.

13. The system of claim 12, wherein the ancillary device presentation container is included within a page description language (PDL) document having other page object data, said system further comprising printer processing means for rendering the PDL document responsive to the one or more printer commands, said printer processing means comprising processing means for mixing the object area data with the other page object data in accordance with PDL-defined mixing rules.

14. The system of claim 13, wherein the ancillary device presentation container is a Mixed Object Document Content Architecture (MO:DCA) presentation container included within a MO:DCA page, said processing means for mixing further comprising processing means for mixing the object area data with the other page object data in accordance with the sequential order in which the MO:DCA presentation container occurs with respect to the other page object data within the MO:DCA page.

15. The system of claim 13, wherein said printer processing means further comprises processing means for rendering the object area data on a print medium in accordance with an object area location specifier included with the object area data, said object area location specifier specifying the offset of the object area origin with respect to a page origin.

16. The system of claim 15, further comprising processing means for translating the offset specified by the object area location specifier to an ancillary print medium offset.

17. The system of claim 16, further comprising ancillary print interface processing means for generating an ancillary device print data frame containing the translated offset.

18. The system of claim 12, wherein said processing means for converting the ancillary device presentation container into one or more printer commands comprises processing means for generating a printer command container having a data field and a control field.

19. The system of claim 18, wherein the control field includes object area data corresponding to the object area data contained in the object area field of the ancillary device presentation container.

20. The system of claim 18, wherein the data field includes a print data format ID field specifying format data corresponding to ancillary printer interface data contained in the print data field of the ancillary device presentation container.

21. The system of claim 20, wherein the data field includes object data to be rendered by an ancillary printer device.

22. The system of claim 21, further comprising processing means for generating an ancillary device print data frame containing the printer command container object data and the print data format ID.

23. A computer program product for processing a print job distributed between the printer and at least one ancillary printer device, wherein said computer program product includes computer-executable instructions for performing a method comprising:
receiving an ancillary device presentation container having an object area field containing object area data and a print data field containing print data; and
converting the ancillary device presentation container into one or more printer commands, said converting comprising:
identifying the ancillary device presentation container as having a presentation space mapping specified as an ancillary device interface mapping, and in response thereto, generating printer commands directing the printer to render the object area data and to defer rendering the print data to an ancillary printer device.

24. The program product of claim 23, wherein the ancillary device presentation container is included within a page description language (PDL) document having other page object data, said method further comprising utilizing the printer to render the PDL document responsive to the one or more printer commands, said rendering comprising mixing the object area data with the other page object data in accordance with PDL-defined mixing rules.

25. The program product of claim 24, wherein the ancillary device presentation container is a Mixed Object Document Content Architecture (MO:DCA) presentation container included within a MO:DCA page, said mixing further comprising mixing the object area data with the other page object data in accordance with the sequential order in which the MO:DCA presentation container occurs with respect to the other page object data within the MO:DCA page.

26. The program product of claim 24, wherein said utilizing the printer to render the PDL document further comprises rendering the object area data on a print medium in accordance with an object area location specifier included with the object area data, said object area location specifier specifying the offset of the object area origin with respect to a page origin.

27. The program product of claim 26, wherein said method further comprises translating the offset specified by the object area location specifier to an ancillary print medium offset.

28. The program product of claim 27, wherein said method further comprises generating an ancillary device print data frame containing the translated offset.

29. The program product of claim 23, wherein said converting the ancillary device presentation container into one or more printer commands comprises generating a printer command container having a data field and a control field.

30. The program product of claim 29, wherein the control field includes object area data corresponding to the object area data contained in the object area field of the ancillary device presentation container.

31. The program product of claim 29, wherein the data field includes a print data format ID field specifying format data corresponding to ancillary printer interface data contained in the print data field of the ancillary device presentation container.

32. The program product of claim 31, wherein the data field includes object data to be rendered by an ancillary printer device.

33. The program product of claim 32, wherein said method further comprises generating an ancillary device print data frame containing the printer command container object data and the print data format ID.

34. A computer-readable medium having stored thereon a data structure comprising:
a page description language (PDL) presentation container object containing data identifying the PDL presentation container as an ancillary device presentation container;
a first field within the PDL presentation container containing data representing an object area;
a second field within the PDL presentation container containing data representing a UP3i print data format ID; and
a third field within the PDL presentation container containing data representing ancillary device print data to be rendered in accordance with the UP3i print data format ID.
